(19) United States
(12) Patent Application Publication
(10) Pub. No.: US 2018/0306754 A1
(43) Pub. Date: Oct. 25, 2018

(54) METHOD OF DETERMINING ONE PHYSICOCHEMICAL PARAMETER OF A CHEMICAL AGENT IN A FLUID AND A SYSTEM THEREFOR

(71) Applicant: Plastic Omnium Advanced Innovation and Research, Bruxelles (BE)

(72) Inventor: Jurgen DEDEURWAERDER, Relegem (BE)

(73) Assignee: Plastic Omnium Advanced Innovation and Research, Bruxelles (BE)

(21) Appl. No.: 15/767,792

(22) PCT Filed: Oct. 13, 2016
(86) PCT No.: PCT/EP2016/074623

§ 371 Date: Apr. 12, 2018

(30) Foreign Application Priority Data
Oct. 13, 2015 (EP) 15189624.8

(51) Int. Cl. G01N 29/22; G01N 29/024; F01N 3/20

(52) U.S. Cl. CPC G01N 29/222; G01N 29/024; F01N 3/2066; F01N 2610/02; G01N 2291/02818; G01N 2291/02827; G01N 2291/02863; G01N 2291/02809

(57) ABSTRACT

A method of determining one physicochemical parameter of a chemical agent in a fluid is provided the method comprising the steps of: providing a pressurized fluid of said chemical agent upstream of a dosing unit in a line; changing the opening condition of said dosing unit at a determinable time to to provide a dosing of said fluid or a change in the dosing of said fluid; determining the time, tₚ, at which the pressure wave in said line resulting from the pressure drop upon changing the opening condition of said dosing unit is detected at a known distance, d, from said dosing unit; determining the velocity of wave propagation from said time interval tₚ−to and said known distance, d; and deriving the physicochemical parameter of said chemical agent from said velocity of wave propagation. The invention also pertains to a system for determining the physicochemical parameter of a chemical agent in a fluid, operating according to the same method.

### TECHNICAL FIELD OF THE INVENTION

The present invention relates to a method of determining one physicochemical parameter of a chemical agent in a fluid and a system therefor. In particular it relates to a method of determining the concentration of a chemical agent in a solution.

### BACKGROUND OF THE INVENTION

Various types of system for detecting physicochemical parameters of a fluid are known in the art.

For example, DE 19850799A1 discloses a sensor arrangement for detecting physical parameters of fluids, with electroacoustic converters, which generate and detect acoustic surface waves with given wave modes, a measure for physical properties of fluids, in particular, amongst other things the viscosity of the fluids being detectable from its propagation behaviour along a propagation path, characterised in that the sensor arrangement is located on a substrate on which conductor track structures of such a type are arranged, that alongside the viscosity, the temperature and also at least the dielectric constants of the fluid can be detected. It is a disadvantage of this system, that acoustic surface waves must be actively generated in order to measure the properties of the fluid.

There is a need for compact and efficient systems for correctly detecting the physicochemical parameters of a chemical agent in a fluid, so as so to improve control of the amount of fluid to be supplied to a consuming unit, for example an injector of a SCR system, a fuel system, a fuel cell, etc.

### SUMMARY OF THE INVENTION

It is an object of the present invention to provide a system for correctly detecting one physicochemical parameter of the chemical agent in a fluid in the consuming unit, so as to improve control of the amount of agent to be supplied, in particular under the form of a plausibility check on the reading of an existing sensor allowing the measure of the corresponding physicochemical parameter required.

Surprisingly the precision with which propagation times can be measured enables the propagation speed of pressure waves in a hydraulic line to be used to estimate the physicochemical parameter of a chemical agent in a fluid.

For example, in a SCR system a variation of ca. 1 ms in a transit time of ca. 30 ms being observed for a variation in concentration of an aqueous solution of urea between 10% and 40% by weight.

The propagation-speed of pressure waves (and acoustics) in a hydraulic line depends on the dimensions of the line, upon the Young modulus of the line material and of the ratio bulk modulus/density of the liquid in the line. For example, for the specific case of SCR application, there is a pump to provide the pressure (typically 5 bar) in the line, an injector to spray the liquid in the exhaust pipe and a hydraulic line connecting both. This hydraulic line has a certain length. At the instance the injector is opened (closed), the pressure decreases (increases) locally. This pressure variation is given in the case of the line being a pipe by the expression:

$$c = \sqrt{\frac{B / ρ}{1 + \frac{DB}{eE}}}$$

where c is the speed of pressure propagation of the acoustic wave travelling backwards in the line material as a result of the opening of the valve, B is the bulk modulus of the liquid, ρ is the density of the liquid, D is the external diameter of the pipe, e is the thickness of the pipe and E is the Young's modulus of the pipe material. This expression reflects propagation through the line by two mechanisms: (i) the propagation of the deformation of the line, which will depend on the diameter, the wall thickness and the Young's modulus of the line, which parameters are in principle known; and (ii) the local compression and expansion of the liquid, which is determined by two properties: the density and the Bulk modulus. Mechanism (ii) is the dominant mechanism if (DB)/(eE)<<1. Then determination of the speed of this pressure wave propagation (or the time for this propagation, since the length of the line is known) enables the determination of the Bulk modulus divided by the density according to the approximated equation:

$$c = \sqrt{\frac{B}{ρ}}$$

If mechanism (ii) is not the dominant mechanism this equation does not hold and corrections have to be made. This is in part a function of the diameter and wall-thickness of the pipe, but is mainly determined by the Young's modulus of the wall material.

It is clear from the above that the approximated equation can be rendered applicable by a judicious choice of the material of the pipe, viz. by choosing a pipe material with a high Young's modules, such as steel (E=200 GPa).

The impact of the Young's modulus can be obtained by comparing the estimated wave propagation speed of different liquids through steel and PVC piping: the wave propagation speed in glycerol with a bulk modulus of 4.5 GPa is 1890 m/s which is reduced to 1400 m/s in steel piping (E=200 GPa) and 380 m/s in PVC piping (E=2.4-4.1 GPa); whereas the propagation speed in water with a bulk modulus of 2.2 GPa is 1480 m/s which is reduced to 1100 m/s in steel piping and 300 m/s in PVC piping. These data show that the ability of this method of determining the concentration of a chemical agent to distinguish concentration differences will increase with increasing Young's modulus of the pipe materials with maximum differentiation when the criterion (DB)/(eE)<<1 is fulfilled. However, the accuracy with which the concentration of a chemical agent in a solution needs to be determined is much lower for plausibility purposes (i.e., for checking the plausibility of a value obtained by using another sensor, whether an incorrect measurement or a defective sensor) than for other purposes.

According to a first aspect of the present invention, a method of determining one physicochemical parameter of a chemical agent in a fluid is provided, the method comprising the steps of: providing a pressurized fluid of said chemical agent upstream of a dosing unit, for example an injection valve, in a line; changing the opening condition of said dosing unit at a determinable time t₀ to provide a dosing of said fluid or a change in the dosing of said fluid; determining the time, tₚ, at which the pressure wave in said line resulting from the pressure drop (due to release of pressure) upon changing the opening condition of said dosing unit is detected at a known distance, d, from said dosing unit; determining the velocity of wave propagation from said time interval tₚ−t₀ and said known distance, d; and deriving the physicochemical parameter of said chemical agent from said velocity of wave propagation.

The term “chemical agent” is used with reference to any material with a definite chemical composition and characteristic physicochemical parameters.

The chemical agent can be any fluid material. It can be dissolved in a liquid, in a gas, in a mixture of both.

In an embodiment wherein the chemical agent is in liquid, preferably in a solution, more preferably in an aqueous solution, the chemical agent can be non-limitatively urea, ammonia, alcohol or blends thereof.

In another embodiment wherein the chemical agent is liquid, the chemical agent can be non-limitatively fuel. “Fuel” refers to any hydrocarbons or a mixture of hydrocarbons that are used to formulate a fuel composition such as gasoline or diesel fuel.

In another embodiment wherein the chemical agent is in a gas the chemical agent can be non-limitatively ammonia, fuel gas (i.e. light hydrocarbons).

The term “physicochemical parameter” is used with reference to a physical or chemical property characterising a chemical agent. One physicochemical parameter can be non-limitatively one of the following one of the list: concentration, viscosity, density, refracting index, bulk modulus, electrical property, optical property, thermal conductivity, Reid Vapour Pressure (RVP), octane number, cetane number or any other one known by the state-of-the-art.

The term “upstream” is used with reference to the normal direction of flow of the fluid when the dosing unit (injector) is active; hence, a position “upstream of a dosing unit” refers to the non-injecting side of the dosing unit. The term “pressurized” refers to the fact that the pressure of the fluid upstream of the dosing unit is sufficiently high to cause fluid to flow into and through the dosing unit when the dosing unit is opened; in a particular embodiment, the fluid may be pressurized up to 3 bar, preferably even up to 5 bar.

In an embodiment, the line comprises a material having a Young's modulus of at least 69 GPa, preferably at least 100 GPa, most preferably at least 200 GPa.

In an embodiment, the physicochemical parameter of said chemical agent is derived with the assistance of look-up tables or polynomials.

According to a second aspect of the present invention a system is provided for determining one physicochemical parameter of a chemical agent in a fluid, said system comprising a means of pressurizing said fluid, a line arranged between said means of applying pressure and an dosing unit having different opening conditions, means for detecting a change in pressure at a known distance from said dosing unit, a means of establishing a time difference between a time at which the opening condition of said dosing unit changes and a time at which the pressure wave in said fluid resulting therefrom is detected by said means for detecting a change in pressure, and a processing means configured to derive the physicochemical parameter of said chemical agent from said time difference.

In an embodiment, the means for detecting a change in pressure comprises a pressure sensor such as for example a piezo-electric transducer (e.g., a piezoresistive sensor or a piezoelectric sensor), a capacitive sensor, or an electromagnetic sensor. In another embodiment, the means for pressurizing said fluid comprises a pump driven by an electrical current, and said means for detecting a change in pressure comprises a current sensor arranged on said pump.

According to a third aspect of the present invention, the use is provided of the second aspect of the present invention for checking the plausibility of one physicochemical parameter of the chemical agent in a fluid determined by another sensor present in the system.

According to a fourth aspect of the present invention a vehicular selective catalytic reduction assembly is provided, said assembly comprising the system of the second aspect of the present invention.

According to a fifth aspect of the present invention a fuel system assembly is provided, said assembly comprising the system of the second aspect of the present invention.

According to a sixth aspect of the present invention, a motor vehicle is provided comprising the system of the second aspect of the present invention.

Particular and preferred aspects of the invention are set out in the accompanying independent and dependent claims. Features from the dependent claims may be combined with features of the independent claims and with features of other dependent claims as appropriate and not merely as explicitly set out in the claims.

Although there has been constant improvement, change and evolution of devices in this field, the present concepts are believed to represent substantial new and novel improvements, including departures from prior practices, resulting in the provision of more efficient, stable and reliable devices of this nature.

The above and other characteristics, features and advantages of the present invention will become apparent from the following detailed description, taken in conjunction with the accompanying drawings, which illustrate, by way of example, the principles of the invention. This description is given for the sake of example only, without limiting the scope of the invention. The reference figures quoted below refer to the attached drawings.

### BRIEF DESCRIPTION OF THE DRAWINGS

FIG. 1 shows a simulated plot of pressure against time for an initial pressure of 5 bar for urea concentrations varying between 10 and 40% by weight and the injector side (lower set of curves) and at the pump side (upper set of curves).

FIG. 2 shows a magnified part of FIG. 1 between 99.124 and 99.130 s in which curves A, B, C and D are the characteristics for aqueous solutions with 10% by weight, 20% by weight, 30% by weight and 40% by weight of urea respectively.

FIG. 3 illustrates schematically a system for determining the concentration of a chemical agent in a solution, according to a particular embodiment of the present invention.

FIG. 4 illustrates schematically a system for determining a physicochemical parameter of fuel in a fluid, according to a particular embodiment of the present invention.

In the different figures, the same reference signs refer to the same or analogous elements.

### DESCRIPTION OF ILLUSTRATIVE EMBODIMENTS

### Definitions

The term “opening condition”, as used in disclosing the present invention, means fully open and any definable condition between fully open and completely shut.

The term “line”, as used in disclosing the present invention, means any means capable of transporting a solution and includes entities with a circular, elliptical, rectangular or square cross-section.

The invention will now be described by a detailed description of several embodiments of the invention. It is clear that other embodiments of the invention can be configured according to the knowledge of persons skilled in the art without departing from the true spirit or technical teaching of the invention, the invention being limited only by the terms of the appended claims.

It is to be understood that although preferred embodiments, specific constructions and configurations, as well as materials, have been discussed herein for devices according to the present invention, various changes or modifications in form and detail may be made without departing from the scope and spirit of this invention. Steps may be added or deleted to methods described within the scope of the present invention.

While the invention is described hereinafter with limited number of examples, it is not limited thereto. In the following description, the reference to urea or fuel solutions is exemplary, and not intended to be limiting.

Method of Determining the Physicochemical Parameter of a Chemical Agent in a Fluid

According to a first aspect of the present invention, a method of determining one physicochemical parameter of a chemical agent in a fluid is provided, the method comprising the steps of: providing a pressurized fluid of said chemical agent upstream of a dosing unit in a line; changing the opening condition of said dosing unit at a determinable time t₀ to provide a dosing of said fluid or a change in the dosing of said fluid; determining the time, tₚ, at which the pressure wave in said line resulting from the pressure drop upon changing the opening condition of said dosing unit is detected, for example by a pressure sensor, at a known distance, d, from said valve; determining the velocity of wave propagation from said time interval tₚ−t₀ and said known distance, d; and deriving the physicochemical parameter of said chemical agent from said velocity of wave propagation.

According to a preferred embodiment of the first aspect of the present invention, the means of exactly establishing the time at which the valve opens may be a pressure sensor, the control signal changing the opening condition of the injector or an injector current pattern indicative of the injector opening.

According to another preferred embodiment of the first aspect of the present invention, the pressure drop is detected by means of a pressure sensor in said line.

According to another preferred embodiment of the first aspect of the present invention, is the pressure drop is detected by reference to the motor current information of said pump.

According to another preferred embodiment of the first aspect of the present invention, said chemical agent is urea.

According to another preferred embodiment of the first aspect of the present invention, said solution is an aqueous urea solution.

According to another preferred embodiment of the first aspect of the present invention, said chemical agent is ammonia.

According to another preferred embodiment of the first aspect of the present invention, said solution is an aqueous ammonia solution.

According to another preferred embodiment of the first aspect of the present invention, said chemical agent is a mixture of urea and ammonia.

According to another preferred embodiment of the first aspect of the present invention, said solution is a mixture of an aqueous urea solution and an aqueous ammonia solution.

According to another preferred embodiment of the first aspect of the present invention, said chemical agent is ethanol.

According to another preferred embodiment of the first aspect of the present invention, said chemical agent is aqueous ethanol solution.

According to another preferred embodiment of the first aspect of the present invention, said chemical agent is fuel.

According to another preferred embodiment of the first aspect of the present invention, said line comprises a material having a Young's modulus of at least 69 GPa.

According to another preferred embodiment of the first aspect of the present invention, said line comprises a material having a Young's modulus of at least 100 GPa.

According to another preferred embodiment of the first aspect of the present invention, said line comprises a material having a Young's modulus of at least 200 GPa.

According to another preferred embodiment of the first aspect of the present invention, said method further comprises the step of injecting said solution of said chemical agent into an exhaust line of a vehicle.

According to another preferred embodiment of the first aspect of the present invention, said method further comprises the step of injecting said fluid of said chemical agent into a fuel cell of a vehicle.

According to another preferred embodiment of the first aspect of the present invention, said method further comprises the step of injecting said fluid of said chemical agent into a consuming unit of a vehicle.

According to another preferred embodiment of the first aspect of the present invention, said line comprises a material selected from the group consisting of aluminium, aramid, bronze, brass, titanium, copper, steel, molybdenum and graphene.

According to another preferred embodiment of the first aspect of the present invention, said line comprises a material selected from the group consisting of aramid, bronze, brass, titanium, copper, steel, molybdenum and graphene.

According to another preferred embodiment of the first aspect of the present invention, said line comprises a material selected from the group consisting of steel, molybdenum and graphene.

According to another preferred embodiment of the first aspect of the present invention, said chemical agent is urea as an aqueous solution.

According to another preferred embodiment of the first aspect of the present invention, when said solution of said chemical agent is maintained at a predetermined temperature.

According to another preferred embodiment of the first aspect of the present invention, said chemical agent is ammonia in a fluid.

According to another preferred embodiment of the first aspect of the present invention, when said fluid of said chemical agent is maintained at a predetermined temperature.

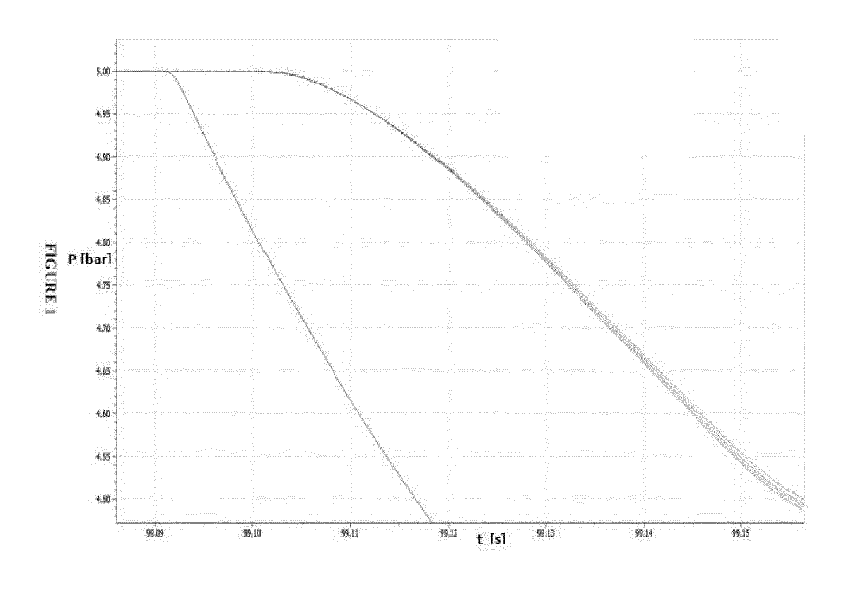

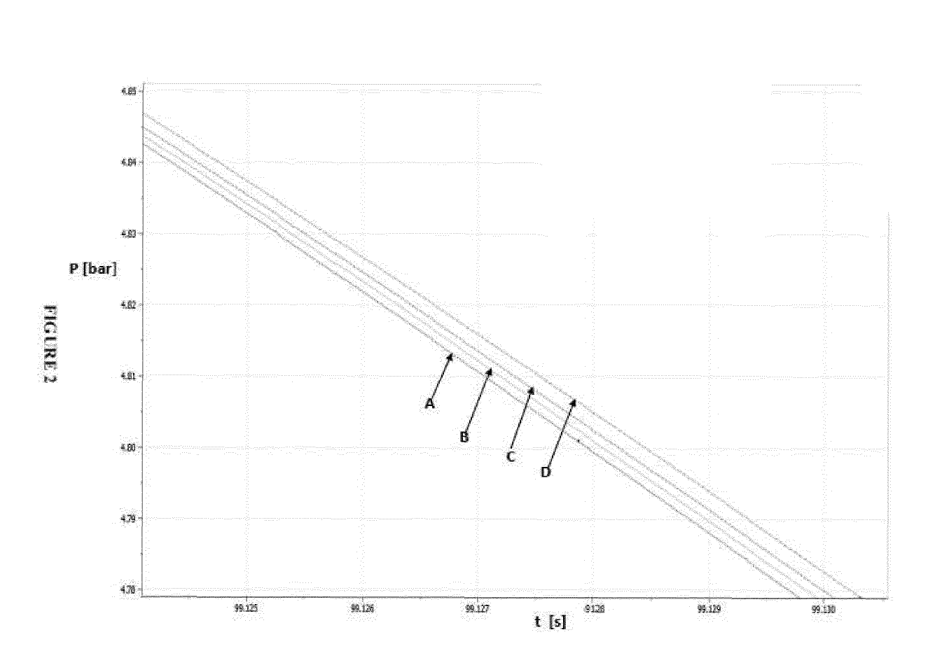

According to another preferred embodiment of the first aspect of the present invention, said method further comprises the step of measuring the temperature of said chemical agent fluid and the thereby measured temperature is taken into account in calculating said physicochemical parameter of said chemical agent in said fluid with the assistance of look-up tables. FIG. 1 shows a simulated plot of pressure against time for an initial pressure of 5 bar applied by a rotary pump for urea concentrations varying between 10 and 40% by weight and the injector side (lower set of curves) and at the pump side (upper set of curves) and FIG. 2 shows a magnified part of FIG. 1 between 99.124 and 99.130 s in which curves A, B, C and D are the characteristics for aqueous solutions with 10% by weight, 20% by weight, 30% by weight and 40% by weight of urea respectively at the pump side of the injector.

The set of curves at the pump side exhibits a ca. 1 ms spread in a total wave propagation time of ca. 30.7 ms between concentrations of 10 and 40% by weight.

The arrival time window of 1 ms is fairly small i.e. the spread in propagation wave arrival times for urea concentrations between 10 and 40% by weight, but in terms of the propagation time of about 30.7 ms is about 3% thereof, which taking the accuracy of time determination into account is accurately measureable. What is also clear from the ripple on these simulated plots is the presence of sinusoidal noise resulting from the action of the rotary pump.

Noise can arise from different sources: from the pump applying the pressure, from imperfections in the piping walls, generated by the injection process and from the system. These are definable and hence can be filtered out.

### System

According to a second aspect of the present invention a system (1) is provided for determining one physicochemical parameter such as the concentration of a chemical agent in a fluid, said system (1) comprising a means of pressurizing said fluid (2), a line (3) arranged between said means of applying pressure (2) and a dosing unit having different opening conditions (4), a means for detecting a change in pressure (5) at a known distance from said dosing unit (4), a means of establishing a time difference (6) between a time at which the opening condition of said dosing unit (4), changes and the time at which the pressure wave in said fluid resulting therefrom is detected by said means for detecting a change in pressure (5), and a processing means (7) configured to derive the concentration of said chemical agent from said time difference.

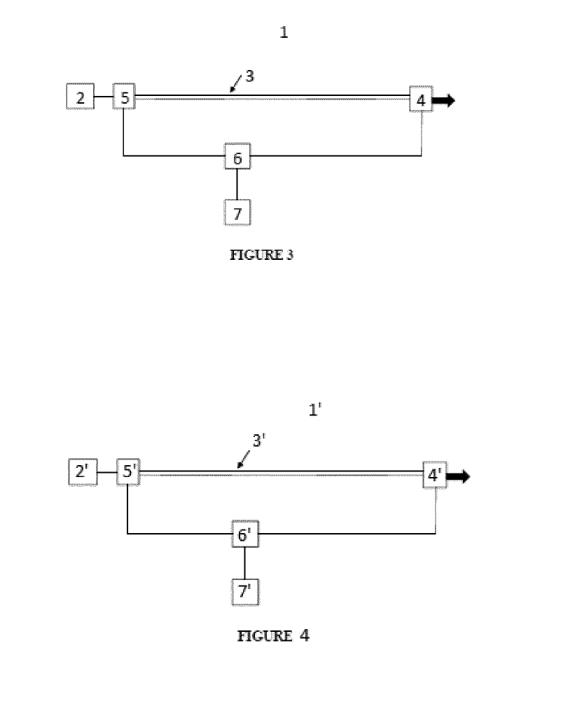

FIG. 3 shows a schematic drawing of a system (1), according to the present invention, in which (2) represents a means of applying pressure to the fluid, (3) represents a line from which the fluid is injected, (4) represents a dosing unit, (5) represents a pressure-wave detection means, (6) represents a means of establishing the time difference tₚ−t₀ and (7) represents a processing means.

The processing means may be implemented in dedicated hardware (e.g., ASIC), configurable hardware (e.g., FPGA), programmable components (e.g., a DSP or general purpose processor with appropriate software), or any combination thereof. The same component(s) may also include other functions, and may for example form part of a vehicle's ECU.

According to a preferred embodiment of the second aspect of the present invention, said system further comprises a means of calculating said concentration of a chemical agent in fluid from the velocity of wave propagation of said pressure wave.

Means for pressurizing a fluid include rotary and piston pumps. According to a preferred embodiment of the second aspect of the present invention, said means of pressurizing comprises a rotary pump.

The means of exactly establishing the time at which the valve opens may be a pressure sensor, the control signal changing the opening condition of the injector or an injector current pattern indicative of the injector opening.

According to another preferred embodiment of the second aspect of the present invention, said means for detecting a change in pressure is a pressure sensor.

Any pressure sensor, otherwise known as pressure transducers, pressure transmitters, pressure senders, pressure indicators and piezometers, known to persons skilled in the art may be used. Types include piezoresistive in which strain gauges using bonded or formed strain gauges are used to detect strain due to applied pressure, resistance increasing as pressure deforms the material; capacitive using a diaphragm and pressure cavity to create a variable capacitor to detect strain due to applied pressure, capacitance decreasing as pressure deforms the diaphragm; electromagnetic which measure the displacement of a diaphragm by means of changes in inductance (reluctance), LVDT, Hall Effect, or by eddy current principle; piezoelectric using the piezoelectric effect in certain materials such as quartz to measure the strain upon the sensing mechanism due to pressure.

According to another preferred embodiment of the second aspect of the present invention, the means for pressurizing said fluid comprises a pump driven by an electrical current, and said means for detecting a change in pressure (5) comprises a current sensor arranged on said pump.

According to another preferred embodiment of the second aspect of the present invention, said line comprises a material having a Young's modulus of at least 69 GPa.

According to another preferred embodiment of the second aspect of the present invention, said line comprises a material having a Young's modulus of at least 100 GPa.

According to another preferred embodiment of the second aspect of the present invention, said line comprises a material having a Young's modulus of at least 200 GPa.

According to another preferred embodiment of the second aspect of the present invention, said line comprises a material selected from the group consisting of aluminium, aramid, bronze, brass, titanium, copper, steel, molybdenum and graphene.

According to another preferred embodiment of the second aspect of the present invention, said line comprises a material selected from the group consisting of steel, molybdenum and graphene.

According to another preferred embodiment of the second aspect of the present invention, said chemical agent is urea as an aqueous solution.

According to another preferred embodiment of the second aspect of the present invention, said chemical agent is ammonia as an aqueous solution.

According to another preferred embodiment of the second aspect of the present invention, said chemical agent is ethanol as an aqueous solution. This embodiment is applied in fuel cell system.

According to another particular embodiment of the second aspect of the present invention, said chemical agent is a mixture of a urea aqueous solution and a converted urea aqueous solution.

In this particular embodiment, the aqueous urea solution, for example AdBlue® solution (a 32.5% commercial aqueous solution of urea) is stored into a tank (not represented). The aqueous urea solution is converted into ammonia aqueous solution (i.e. converted urea aqueous solution) in a decomposition unit (not represented) which can comprise enzyme retaining structures containing a protein component or a protein sequence acting as a bio-agent. Such bio-agent is for example the enzyme urease, which is adapted to decompose the urea into ammonia. The term “ammonia aqueous solution” refers to a mixture which comprises ammonia, water and carbon dioxide and other compounds than ammonia (hydrated ammonia/ammonium hydroxide). The solution may also comprise a residue of urea aqueous solution (i.e. a portion of the urea solution that has not been decomposed).
In this particular embodiment, the converted solution is stored in a Buffer tank (not represented). The solution is pressurized by means of applying pressure (2) then injected through the line (3) to the dosing unit (4) (i.e. ammonia aqueous solution injector) at a vehicle consuming unit such as exhaust line or fuel cell (not represented).
In this particular embodiment, the physicochemical parameter to determine can be the remaining concentration of urea in the converted solution. It is determined by means of calculating said concentration from the velocity of wave propagation of said pressure wave into the line as previously explained.
Thus, from this determination, the rate of conversion of urea into ammonia can be deduced. This particular embodiment can be applied in SCR system or in fuel cell system.

FIG. 4 shows a schematic drawing of another embodiment of a system (1′), according to the present invention, in which (2′) represents a means of applying pressure to the fuel, (3′) represents a line from which the fuel is injected, (4′) represents injector, (5′) represents a pressure-wave detection means, (6′) represents a means of establishing the time difference tₚ−t₀ and (7′) represents a processing means.

The system (1′) is provided for determining one physicochemical parameter such as the octane number of fuel or cetane number of fuel or Reid Vapour Pressure (RVP) of fuel.

The processing means may also be implemented in dedicated hardware (e.g., ASIC), configurable hardware (e.g., FPGA), programmable components (e.g., a DSP or general purpose processor with appropriate software), or any combination thereof. The same component(s) may also include other functions, and may for example form part of a vehicle's ECU.

According to a preferred embodiment of the second aspect of the present invention, said system further comprises a means of calculating said physicochemical parameter of fuel from the velocity of wave propagation of said pressure wave.

Means for pressurizing fuel include rotary and piston pumps. According to a preferred embodiment of the second aspect of the present invention, said means of pressurizing comprises a rotary pump.

The means of exactly establishing the time at which the valve opens may be a pressure sensor, the control signal changing the opening condition of the injector or an injector current pattern indicative of the injector opening.

According to another preferred embodiment of the second aspect of the present invention, said means for detecting a change in pressure is a pressure sensor.

Any pressure sensor, otherwise known as pressure transducers, pressure transmitters, pressure senders, pressure indicators and piezometers, known to persons skilled in the art may be used. Types include piezoresistive in which strain gauges using bonded or formed strain gauges are used to detect strain due to applied pressure, resistance increasing as pressure deforms the material; capacitive using a diaphragm and pressure cavity to create a variable capacitor to detect strain due to applied pressure, capacitance decreasing as pressure deforms the diaphragm; electromagnetic which measure the displacement of a diaphragm by means of changes in inductance (reluctance), LVDT, Hall Effect, or by eddy current principle; piezoelectric using the piezoelectric effect in certain materials such as quartz to measure the strain upon the sensing mechanism due to pressure.

According to another preferred embodiment of the second aspect of the present invention, the means for pressurizing said fuel comprises a pump driven by an electrical current, and said means for detecting a change in pressure (5) comprises a current sensor arranged on said pump.

According to another preferred embodiment of the second aspect of the present invention, said line comprises a material having a Young's modulus of at least 69 GPa.

According to another preferred embodiment of the second aspect of the present invention, said line comprises a material having a Young's modulus of at least 100 GPa.

According to another preferred embodiment of the second aspect of the present invention, said line comprises a material having a Young's modulus of at least 200 GPa.

According to another preferred embodiment of the second aspect of the present invention, said line comprises a material selected from the group consisting of aluminium, aramid, bronze, brass, titanium, copper, steel, molybdenum and graphene.

According to another preferred embodiment of the second aspect of the present invention, said line comprises a material selected from the group consisting of steel, molybdenum and graphene.

According to another preferred embodiment of the second aspect of the present invention, said system further comprises a means of maintaining the temperature of the fluid of said chemical agent at a predetermined temperature.

According to another preferred embodiment of the second aspect of the present invention, a temperature sensor is present in said line.

While the invention has been described hereinabove with reference to specific embodiments, this was done to clarify and not to limit the invention. The skilled person will appreciate that various modifications and different combinations of disclosed features are possible without departing from the scope of the invention. In particular, details that have only been described with reference to the method embodiments may be applied mutatis mutandis to the system embodiments with the same technical effects, and vice versa.

1. A method of determining one physicochemical parameter of a chemical agent in a fluid the method comprising:
providing a pressurized fluid of said chemical agent upstream of a dosing unit in a line;
changing the opening condition of said dosing unit at a determinable time to provide a dosing of said fluid or a change in the dosing of said fluid;
determining the time, tₚ, at which the pressure wave in said line resulting from the pressure drop upon changing the opening condition of said dosing unit is detected in said line at a known distance, d, from said dosing unit;
determining the velocity of wave propagation from said time interval tₚ−tₒ and said known distance, d; and
deriving the physicochemical parameter of said chemical agent from said velocity of wave propagation.

2. The method according to claim 1, wherein a means of exactly establishing the time at which a valve opens may be a pressure sensor, a control signal changing the opening condition of the injector or an injector current pattern indicative of the injector opening.

3. The method according to claim 1, wherein said chemical agent is urea.

4. The method according to claim 3, wherein said fluid is an aqueous urea solution.

5. The method according to claim 1, wherein said physicochemical parameter is the concentration of the chemical agent in the fluid.

6. The method according to claim 1, further comprising the step of injecting said fluid of said chemical agent into an exhaust line of a vehicle.

7. A system for determining one physicochemical parameter of a chemical agent in a fluid, said system comprising a means of pressurizing said fluid, a line arranged between said means of applying pressure and a dosing unit having different opening conditions, means for detecting a change in pressure at a known distance from said dosing unit, a means of establishing a time difference between a time at which the opening condition of said dosing unit changes and a time at which the pressure wave in said fluid resulting therefrom is detected by said means for detecting a change in pressure, and processing means configured to derive the physicochemical parameter of said chemical agent from said time difference.

8. The system according to claim 7, wherein the means for detecting a change in pressure comprises a pressure sensor.

9. The system according to claim 7, wherein the means for pressurizing said fluid comprises a pump driven by an electrical current, and wherein said means for detecting a change in pressure comprises a current sensor arranged on said pump.

10. The system according to claim 7, wherein said means of applying a pressure comprises a rotary pump.

11. The use of a system according to claim 7 checking the plausibility of said physicochemical parameter of said chemical agent in said fluid determined by another sensor.

12. A vehicular selective catalytic reduction assembly comprising a system according to claim 7.

13. A motor vehicle comprising a system according to claim 7.
